(19) United States
(12) Patent Application Publication
(10) Pub. No.: US 2024/0127994 A1
(43) Pub. Date: Apr. 18, 2024

(54) PROCESS FOR PRODUCING A RAW MAGNET

(71) Applicant: MIMPLUS TECHNOLOGIES GMBH & CO. KG, Ispringen (DE)

(72) Inventors: Johannes MAURATH, Ettlingen (DE); Simone SCHUSTER, Renningen (DE)

(21) Appl. No.: 18/276,125

(22) PCT Filed: Dec. 22, 2021
(86) PCT No.: PCT/EP2021/087398

§ 371 Date: Aug. 7, 2023

(30) Foreign Application Priority Data
Feb. 15, 2021 (DE) 10 2021 201 413.5

(51) Int. Cl. H01F 1/057

(52) U.S. Cl. CPC H01F 1/0577

(57) ABSTRACT

A method for manufacturing a raw magnet includes manufacturing a first raw form from a first magnetic base material; manufacturing a second raw form from a second magnetic base material; applying an external magnetic field to at least one raw form selected from a group consisting of the first raw form and the second raw form during and/or after manufacturing of the raw form. Wherein a third raw form is manufactured from the first raw form and the second raw form by joining them together. A separating layer is provided between a first connection surface of the first raw form and a second connection surface of the second raw form. The third raw form is sintered.

The invention relates to a method for manufacturing a raw magnet.

Permanent magnets from the rare earth group are used in a variety of technical applications and are characterised by a particularly high energy product. Neodymium-iron-boron magnets in particular comprise an energy product of up to 400 kJ/m³.

It is known that permanent magnets can be manufactured in sections, in particular in layers. In this section-by-section, in particular layer-by-layer manufacturing, the individual sections, in particular individual layers, are not separated from one another with respect to chemical and/or physical properties.

In particular, when permanent magnets are used together with moving, current-carrying coils, electromagnetic induction takes place in the electrically conductive components involved. In a permanent magnet, this magnetic induction leads to eddy currents. The eddy currents cause the permanent magnet to heat up strongly, which leads to a short-term reduction of the magnetic power or to permanent thermal damage and demagnetisation of the permanent magnet.

The invention is therefore based on the problem of providing a method for manufacturing a raw magnet, in particular for manufacturing a permanent magnet, wherein the disadvantages mentioned, in particular with regard to the permanent magnet to be ultimately manufactured, are at least partially eliminated, preferably avoided.

The problem is solved by providing the present technical teaching, in particular the teaching of the independent claims as well as the embodiments disclosed in the dependent claims and the description.

In particular, the problem is solved by providing a method for manufacturing a raw magnet, wherein a first raw form is manufactured from a first magnetic base material and a second raw form is manufactured from a second magnetic base material. Furthermore, an external magnetic field is applied to at least one raw form selected from a group consisting of the first raw form and the second raw form during manufacturing of the raw form. Alternatively or additionally, an external magnetic field is applied to the at least one raw form after manufacturing of the raw form. Subsequently, a third raw form is manufactured from the first raw form and the second raw form by joining them together. Further, a separating layer is provided between a first connection surface of the first raw form and a second connection surface of the second raw form. The third raw form is sintered, wherein the raw magnet is obtained.

Advantageously, the method is suitable for manufacturing permanent magnets, which are obtained after magnetising the raw magnets, with a complex magnet shape and/or a complex magnetisation. The produced permanent magnet preferably comprises a magnet shape and/or magnetisation which can be adapted to a special requirement. Furthermore, little or no post-processing of the raw magnet is required. Furthermore, during sintering of the third raw form, a substance-to-substance bonding is advantageously produced between the first raw form and the second raw form—possibly mediated via the separating layer—in the region of the connection surfaces.

Advantageously, by means of the separating layer it is possible to separate the first raw form and the second raw form from each other with respect to at least one chemical and/or physical property of the raw forms and in particular of the permanent magnet. In particular, the first connection surface and the second connection surface face each other and are separated from each other or separated with respect to at least one property by the separating layer.

Advantageously, dipoles of the magnetic base material are aligned in a parallel orientation by means of the externally applied magnetic field during manufacturing and/or after manufacturing of the at least one raw form.

In an embodiment, providing the separating layer between the first connection surface of the first raw form and the second connection surface of the second raw form means that the separating layer is configured between the first connection surface and the second connection surface. In another embodiment, it means that the separating layer is disposed between the first connection surface of the first raw form and the second connection surface of the second raw form.

In an embodiment, the third raw form is formed from a plurality of raw forms, in particular a plurality of first raw forms and/or a plurality of second raw forms. In particular, a separating layer is provided in pairs between each two raw forms.

In a further embodiment of the method, the separating layer is configured as at least one closed, that is in particular continuous, separating layer. Alternatively, the separating layer is configured as a separating layer that is not closed or is open in regions, in particular as a plurality of separating layer fragments present in regions. Alternatively, the separating layer is configured in the form of particles on at least one connection surface selected from the first connection surface and the second connection surface.

Preferably, the externally applied magnetic field is generated by a switchable electromagnet and/or a permanent magnet.

In a further embodiment, the at least one raw form, in particular exactly one raw form selected from a group consisting of the first raw form and the second raw form, is manufactured in the externally applied magnetic field. Advantageously, the particles of the magnetic base material from which the at least one raw form is manufactured align themselves according to the externally applied magnetic field while the at least one raw form is being manufactured. Preferably, the magnetic base material of the at least one raw form, in particular of the exactly one raw form, is hard magnetic. In particular, the external magnetic field is applied to the at least one raw form, in particular the exactly one raw form, only during the manufacturing of the at least one raw form, in particular the exactly one raw form. In particular, the external magnetic field is not applied to the at least one raw form, in particular the exactly one raw form, after the manufacturing of the at least one raw form, in particular the exactly one raw form.

In a further embodiment, the external magnetic field is applied to the at least one raw form, in particular to exactly one raw form selected from a group consisting of the first raw form and the second raw form, after manufacturing of the at least one raw form, in particular of the exactly one raw form. In particular, the external magnetic field is applied to the at least one raw form, in particular the exactly one raw form, only after the manufacturing of the at least one raw form, in particular the exactly one raw form. In particular, the external magnetic field is not applied to the at least one raw form, in particular the exactly one raw form, during the manufacturing of the at least one raw form, in particular the exactly one raw form.

In a further embodiment, the external magnetic field is applied to the at least one raw form, in particular to exactly one raw form selected from a group consisting of the first raw form and the second raw form, during and after manufacturing of the raw form, in particular of the exactly one raw form.

In a further embodiment, the first raw form and the second raw form are manufactured in the externally applied magnetic field. In particular, the external magnetic field is applied to the first raw form only during the manufacturing of the first raw form. In addition, the external magnetic field is in particular applied to the second raw form only during the manufacturing of the second raw form. In particular, the external magnetic field is not applied to the first raw form after the manufacturing of the first raw form. In addition, the external magnetic field is in particular not applied to the second raw form after the manufacturing of the second raw form.

In a further embodiment, the external magnetic field is applied to the first raw form and the second raw form after the manufacturing of the first raw form and the second raw form. In particular, the external magnetic field is applied to the first raw form only after the manufacturing of the first raw form. In addition, the external magnetic field is in particular applied to the second raw form only after manufacturing of the second raw form. In particular, the external magnetic field is not applied to the first raw form during the manufacturing of the first raw form. In addition, the external magnetic field is in particular not applied to the second raw form during the manufacturing of the second raw form.

In a further embodiment, the first raw form is manufactured in the externally applied magnetic field. In addition, the external magnetic field is applied to the second raw form after manufacturing of the second raw form. In particular, the external magnetic field is applied to the first raw form only during the manufacturing of the first raw form. In particular, the external magnetic field is not applied to the first raw form after the manufacturing of the first raw form. Additionally, in particular, the external magnetic field is applied to the second raw form only after the manufacturing of the second raw form. In particular, the external magnetic field is not applied to the second raw form during the manufacturing of the second raw form.

In a further embodiment, the second raw form is manufactured in the externally applied magnetic field. Additionally, the external magnetic field is applied to the first raw form after manufacturing the first raw form. In particular, the external magnetic field is applied to the second raw form only during the manufacturing of the second raw form. In particular, the external magnetic field is not applied to the second raw form after the manufacturing of the second raw form. Additionally, in particular, the external magnetic field is applied to the first raw form only after the manufacturing of the first raw form. In particular, the external magnetic field is not applied to the first raw form during the manufacturing of the first raw form.

In a further embodiment, the external magnetic field is applied to the first raw form during and after manufacturing of the first raw form. Additionally, the external magnetic field is applied to the second raw form during and after the manufacturing of the second raw form. Additionally, particularly preferably, the second raw form is heated to the softening temperature while the external magnetic field is applied.

Advantageously, the method is suitable for powdered magnetic starting materials which are formed on the basis of a newly melted alloy, in particular in the form of a cast ingot or in the form of melt-spun material. Alternatively or additionally, the method is suitable for recycled magnetic material and/or contaminated recycled magnetic material. In addition, material obtained by recycling is preferably alloyed with at least one rare earth element, preferably in powdered form, to improve its properties.

The first magnetic base material and/or the second magnetic base material are preferably in a pure form or in a hydrogenated form. The US patent application US 2013/0263699 A1 and the German patent DE 198 43 883 C1 describe a method, called hydrogen decrepitation (HD), for manufacturing a hydrogenated form of the first magnetic base material and/or the second magnetic base material by means of a hydrogen-induced decay.

Preferably, a magnetic primary material is mechanically reduced, in particular by grinding, to a particle size of at least 1 μm to at most 200 μm to obtain a powdered magnetic base material selected from the first magnetic base material and the second magnetic base material.

Preferably, the first magnetic base material and the second magnetic base material are identical. Alternatively, the first magnetic base material and the second magnetic base material are different, in particular the first magnetic base material and the second magnetic base material differ in at least one property selected from a group consisting of a particle size, a particle shape, a particle size distribution, and a chemical composition.

Preferably, the raw magnet is magnetised, wherein a permanent magnet is obtained. The method is then in particular a method for manufacturing a permanent magnet.

According to a further development of the invention, it is provided that the separating layer is configured as an electrical resistance layer which has a lower electrical conductivity than the first magnetic base material and/or the second magnetic base material. Advantageously, permanent magnets are manufactured by means of the method, which—at least locally in the region of the separating layer—comprise a reduced electrical conductance. Thus, these permanent magnets are less susceptible to eddy currents, and thus heating of the permanent magnets during operation, in particular during operation in an electric motor, is reduced, in particular avoided. Furthermore, the permanent magnets are divided into different compartments due to the separating layer, wherein the eddy currents cannot form across several compartments; this has an analogous effect to the configuration of magnets or magnet armatures from a plurality of sheets or laminations separated from each other.

In particular, the separating layer comprises an electrical conductivity which is lower than the electrical conductivity of the first magnetic base material and which is also lower than the electrical conductivity of the second magnetic base material.

In particular, the separating layer comprises an electrical conductivity of less than 10⁵ Siemens per metre, preferably less than 70 000 Siemens per metre. Advantageously, a relevant reduction of the eddy currents already results at these values.

In an embodiment, the separating layer is configured as an electrically insulating layer, wherein the separating layer preferably has an electrical conductivity of less than 10⁻⁶ Siemens per metre.

According to a further development of the invention, it is provided that the separating layer is configured by bringing a separating layer forming substance into contact with at least one connection surface selected from the first connection surface and the second connection surface, in particular by applying it to the at least one connection surface.

In an embodiment, preferably the separating layer forming substance forms the separating layer. Alternatively, preferably the first magnetic base material and/or the second magnetic base material reacts with the separating layer forming substance, wherein the separating layer is formed.

According to a further development of the invention, it is provided that a material is used as the separating layer, which comprises at least one compound selected from a group consisting of aluminium oxide, zirconium oxide, yttrium oxide, neodymium oxide, boron oxide, at least one rare-earth-oxide, neodymium fluoride, praseodymium fluoride, dysprosium fluoride, sodium fluoride, potassium fluoride, at least one rare earth halide, at least one ceramic material, sodium chloride, potassium chloride, ammonium fluoride, aluminium fluoride, ammonium nitrate, potassium nitrate, sodium nitrate, iron nitrate, calcium nitrate, and aluminium nitrate.

Preferably, a material is used as the separating layer forming substance which consists of at least one compound selected from a group consisting of aluminium oxide, zirconium oxide, yttrium oxide, neodymium oxide, boron oxide, at least one rare-earth-oxide, neodymium fluoride, praseodymium fluoride, dysprosium fluoride, sodium fluoride, potassium fluoride, at least one rare-earth-oxide halide, at least one ceramic material, sodium chloride, potassium chloride, ammonium fluoride, aluminium fluoride, ammonium nitrate, potassium nitrate, sodium nitrate, iron nitrate, calcium nitrate, aluminium nitrate, oxygen, nitrogen, fluorine, chlorine, bromine, iodine, at least one oxidizing gas, an oxidizing liquid, in particular an oxidizing acid, in particular concentrated sulphuric acid, fuming sulphuric acid, concentrated nitric acid, fuming nitric acid, aqua regia, water vapour, water, and at least one organic polar solvent.

In an embodiment, the separating layer forming substance comprising or consisting of at least one compound selected from a group comprising aluminium oxide, zirconium oxide, yttrium oxid, neodymium oxide, boron oxide, at least one rare-earth-oxide, neodymium fluoride, praseodymium fluoride, dysprosium fluoride, at least one rare earth halide, and at least one ceramic material, is applied to the first connection surface and/or the second connection surface, wherein the separating layer forming substance forms the separating layer.

In a further embodiment, the separating layer forming substance comprising or consisting of at least one compound selected from a group consisting of sodium fluoride, potassium fluoride, sodium chloride, potassium chloride, ammonium fluoride, aluminium fluoride, ammonium nitrate, potassium nitrate, sodium nitrate, iron nitrate, calcium nitrate, aluminium nitrate, oxygen, nitrogen, fluorine, chlorine, bromine, iodine, at least one oxidizing gas, an oxidizing liquid, in particular an oxidizing acid, in particular concentrated sulphuric acid, fuming sulphuric acid, concentrated nitric acid, fuming nitric acid, aqua regia, water vapour, water, and at least one organic polar solvent, is applied to the first connection surface and/or the second connection surface, wherein the separating layer forming substance reacts with the first magnetic base material and/or the second magnetic base material to form the separating layer.

In particular, the separating layer forming substance, in particular comprising or consisting of at least one compound selected from a group comprising aluminium oxide, zirconium oxide, yttrium oxide, neodymium oxide, boron oxide, at least one rare-earth-oxide, neodymium fluoride, praseodymium fluoride, dysprosium fluoride, at least one rare earth halide, and at least one ceramic material, as a solid, in particular as a flat structure, in particular as a film, applied to the first connection surface and/or the second connection surface. In particular, the flat structure, in particular the film, has a thickness of at most 500 μm, preferably at most 250 μm, preferably at most 100 μm, preferably at most 50 μm, particularly preferably at most 10 μm.

In an embodiment of the separating layer forming substance as a solid, the flat structure, in particular the film, is applied to the first connection surface and/or the second connection surface in a substance-to-substance bonded manner, wherein preferably for applying the flat structure, in particular the film, the first raw form and/or the second raw form, in particular the first connection surface and/or the second connection surface, is heated to a temperature of at least 70° C. to at most 200° C. Preferably, the first raw form and/or the second raw form, in particular the first connection surface and/or the second connection surface, is heated by means of at least one device selected from a laser, a hot air device and an oven.

In a further embodiment of the separating layer forming substance as a solid, the flat structure, in particular the film, is applied to the first connection surface and/or the second connection surface in a form bonded manner. In particular, the flat structure and the first connection surface and/or the second connection surface are connected to each other in a form bonded manner via their respective geometry, in particular via a tongue and groove geometry, a screw thread geometry or a pin hole geometry.

In particular, the separating layer forming substance is applied to the first connection surface and/or the second connection surface in the form of a suspension or a solution. In particular, the suspension comprises particles of the separating layer forming substance having a particle size of at most 100 μm, preferably at most 50 μm, preferably at most 10 μm, preferably at most 1 μm, particularly preferably at most 0.5 μm, wherein the separating layer forming substance particularly comprises at least one compound selected from a group consisting of aluminium oxide, zirconium oxide, yttrium oxide, neodymium oxide, boron oxide, at least one rare-earth-oxide, neodymium fluoride, praseodymium fluoride, dysprosium fluoride, sodium fluoride, potassium fluoride, at least one rare-earth-oxide halide, at least one ceramic material, sodium chloride, potassium chloride, ammonium fluoride, aluminium fluoride, ammonium nitrate, potassium nitrate, sodium nitrate, iron nitrate, calcium nitrate, and aluminium nitrate. In particular, the suspension or solution comprises the separating layer forming substance at a volume concentration of at least 5% to at most 70%. In particular, the suspension or the solution comprises at least one liquid selected from a group consisting of at least one polar organic solvent, in particular isopropanol, acetone, or ethanol, at least one nonpolar organic solvent, in particular cyclohexane, n-hexane, or n-heptane, and water.

In particular, the separating layer forming substance is applied in the form of a liquid to the first connection surface and/or the second connection surface. In particular, the liquid comprises or consists of at least one substance selected from a group consisting of an oxidizing liquid, in particular an oxidizing acid, in particular concentrated sulphuric acid, fuming sulphuric acid, concentrated nitric acid, fuming nitric acid, aqua regia, and water.

In an embodiment of the separating layer forming substance in the form of a substance selected from a group consisting of a liquid, a suspension and a solution, the substance is preferably sprayed onto the first connection surface and/or the second connection surface. Alternatively or additionally, the first connection surface and/or the second connection surface is preferably coated with the substance. Alternatively or additionally, at least the first connection surface and/or the second connection surface, in particular the first raw form and/or the second raw form, is immersed in the substance. Preferably, the substance comprises a temperature of at least 20° C. and at most 100° C. when applied to the first connection surface and/or the second connection surface. Preferably, the first raw form and/or the second raw form, in particular the first connection surface and/or the second connection surface, is heated to a temperature of at least 50° C. to at most 150° C., particularly preferably at least 70° C. to at most 150° C., during and/or after the application of the substance. Particularly preferably, the first raw form and/or the second raw form, in particular the first connection surface and/or the second connection surface, is heated for at least 10 minutes to at most 120 minutes after the application of the substance. Preferably, the first raw form and/or the second raw form, in particular the first connection surface and/or the second connection surface, is heated by means of at least one device selected from a laser, a hot air device and an oven.

In particular, the separating layer forming substance is applied in the form of an aerosol to the first connection surface and/or the second connection surface. In particular, the aerosol comprises particles of the separating layer forming substance having a particle size of at most 50 μm, preferably at most 10 μm, preferably at most 1 μm, preferably at most 0.5 μm, particularly preferably at most 0.1 μm, wherein the separating layer forming substance particularly comprises at least one compound selected from a group consisting of aluminium oxide, zirconium oxide, yttrium oxide, neodymium oxide, boron oxide, at least one rare-earth-oxide, neodymium fluoride, praseodymium fluoride, dysprosium fluoride, sodium fluoride, potassium fluoride, at least one rare-earth-oxide halide, at least one ceramic material, sodium chloride, potassium chloride, ammonium fluoride, aluminium fluoride, ammonium nitrate, potassium nitrate, sodium nitrate, iron nitrate, calcium nitrate, and aluminium nitrate. In particular, the aerosol comprises the separating layer forming substance at a volume concentration of at least 1% to at most 30%. In particular, the aerosol comprises at least one gas selected from a group consisting of at least one inert gas, in particular helium and argon, oxygen, nitrogen, fluorine, chlorine, bromine, iodine, at least one oxidizing gas, and water vapour.

In particular, the separating layer forming substance is applied in the form of a gas to the first connection surface and/or the second connection surface. In particular, the gas comprises or consists of at least one substance selected from a group consisting of oxygen, nitrogen, fluorine, chlorine, bromine, iodine, at least one oxidizing gas, and water vapour.

In an embodiment of the separating layer forming substance in the form of an aerosol or a gas, preferably the aerosol or the gas is sprayed or blown onto the first connection surface and/or the second connection surface. Alternatively or additionally, at least the first connection surface and/or the second connection surface, in particular the first raw form and/or the second raw form, is exposed to an atmosphere comprising the aerosol or the gas. Preferably, the aerosol or the gas comprises a temperature of at least 15° C. and at most 200° C. when applied to the first connection surface and/or the second connection surface.

According to a further development of the invention, it is provided that as the first magnetic base material and/or the second magnetic base material a material is used comprising particles of an RₓT_{y}B alloy. Preferably, as the first magnetic base material and/or the second magnetic base material, a material is used which consists of particles of an RₓT_{y}B alloy. In particular, preferably, the first magnetic base material and/or the second magnetic base material comprises particles of an NdₓFe_{y}B alloy or consists of particles of an NdₓFe_{y}B alloy.

Preferably, the first magnetic base material and/or the second magnetic base material comprises particles of an RₓT_{y}B alloy and particles of a rare-earth-rich phase. In particular, the first magnetic base material and/or the second magnetic base material preferably consists of a mixture of particles of an RₓT_{y}B alloy and particles of a rare-earth-rich phase. Preferably, the first magnetic base material and/or the second magnetic base material comprises or consists of particles of an NdₓFe_{y}B alloy and particles of a neodymium-rich phase. In particular, the first magnetic base material and/or the second magnetic base material preferably comprises or consists of a mixture of particles of an NdₓFe_{y}B alloy and particles of a neodymium-rich phase.

In the context of the present technical teachings, R represents a rare earth element, i.e. an element from the rare earth group, T represents at least one element selected from a group consisting of iron and cobalt, and B represents the element boron. In particular, the elements iron and cobalt partially or completely substitute each other in such a way that either only iron or only cobalt or any iron-cobalt mixture is present. Preferably, the rare earth element is neodymium. In a preferred embodiment, the RₓT_{y}B alloy additionally comprises another element, preferably a metal, in particular a transition metal, selected from a group consisting of aluminium, copper, zirconium, gallium, hafnium, and niobium, preferably in trace amounts.

Preferably, the first magnetic base material and/or the second magnetic base material comprises particles of an Nd₂Fe₁₄B alloy or consists of particles of an Nd₂Fe₁₄B alloy.

Preferably, the rare-earth-rich phase, in particular the neodymium-rich phase, comprises at least one rare-earth element, in particular neodymium, or a chemical compound of this rare-earth element, in particular of neodymium. In addition, the rare-earth-rich phase, in particular the neodymium-rich phase, preferably contains at least one further element of the RₓT_{y}B alloy, in particular the NdₓFe_{y}B alloy. Alternatively or additionally, the at least one rare earth element, in particular neodymium, is present in a hydrogenated form. Preferably, the neodymium-rich phase comprises or consists of NdH₂ and/or NdH_{2,7}. Alternatively, in a preferred embodiment, it is possible that the rare-earth-rich phase, in particular the neodymium-rich phase, consists of at least one rare-earth element, in particular of neodymium, or of a chemical compound of this rare-earth element, in particular of neodymium.

Alternatively, the at least one rare earth element, in particular neodymium, is preferably additionally added to the magnetic base material in a hydrogenated form, in particular NdH₂ and/or NdH_{2,7}.

The rare-earth-rich phase preferably forms a phase in the microstructure of the raw magnet which is located at grain boundaries of the microstructure. In particular, the rare-earth-rich phase is enriched at the grain boundaries of the microstructure. In particular, the rare-earth-rich phase is inhomogeneously distributed in the microstructure.

According to a further development of the invention, it is provided that as the first magnetic base material and/or as the second magnetic base material a material is used which comprises at least one compound selected from a group consisting of an aluminium-nickel-cobalt alloy, and a samarium-cobalt alloy.

Preferably, as the first magnetic base material and/or as the second magnetic base material, a material is used consisting of at least one compound selected from a group consisting of an aluminium-nickel-cobalt alloy, and a samarium-cobalt alloy.

In an embodiment of the method, as the first magnetic base material and/or as the second magnetic base material, a samarium-cobalt alloy comprising SmCo₅, preferably consisting of SmCo₅, is used.

In a further embodiment of the method, as the first magnetic base material and/or as the second magnetic base material, a samarium-cobalt alloy comprising Sm₂Co₁₇, iron, copper and zirconium, preferably consisting of Sm₂Co₁₇, iron, copper and zirconium, is used.

According to a further development of the invention, a first external magnetic field is applied to the first raw form during and/or after manufacturing of the first raw form. Furthermore, a second external magnetic field is applied to the second raw form during and/or after manufacturing of the second raw form. Preferably, the first external magnetic field and the second external magnetic field are different from each other, in particular the first external magnetic field and the second external magnetic field are not identical.

In an embodiment of the method, the first raw form is manufactured in the first externally applied magnetic field. In addition, the second raw form is manufactured in the second externally applied magnetic field. In particular, the first external magnetic field is applied to the first raw form only during the manufacturing of the first raw form. In particular, the first external magnetic field is not applied to the first raw form after manufacturing of the first raw form. In addition, the second external magnetic field is in particular applied to the second raw form only during the manufacturing of the second raw form. In particular, the second external magnetic field is not applied to the second raw form after the manufacturing of the second raw form.

In a further embodiment of the method, the first external magnetic field is applied to the first raw form after the manufacturing of the first raw form. Additionally, the second external magnetic field is applied to the second raw form after the manufacturing of the second raw form. In particular, the first external magnetic field is applied to the first raw form only after manufacturing of the first raw form. In particular, the first external magnetic field is not applied to the first raw form during the manufacturing of the first raw form. In addition, the second external magnetic field is in particular applied to the second raw form only after manufacturing of the second raw form. In particular, the second external magnetic field is not applied to the second raw form during the manufacturing of the second raw form.

In a further embodiment of the method, the first raw form is manufactured in the first externally applied magnetic field. In addition, the second external magnetic field is applied to the second raw form after manufacturing of the second raw form. In particular, the first external magnetic field is applied to the first raw form only during the manufacturing of the first raw form. In particular, the first external magnetic field is not applied to the first raw form after the manufacturing of the first raw form. In addition, the second external magnetic field is in particular applied to the second raw form only after the manufacturing of the second raw form. In particular, the second external magnetic field is not applied to the second raw form during the manufacturing of the second raw form.

In a further embodiment of the method, the first external magnetic field is applied to the first raw form after the manufacturing of the first raw form. Additionally, the second raw form is manufactured in the second externally applied magnetic field. In particular, the first external magnetic field is applied to the first raw form only after manufacturing of the first raw form. In particular, the first external magnetic field is not applied to the first raw form during the manufacturing of the first raw form. In addition, the second external magnetic field is in particular applied to the second raw form only during the manufacturing of the second raw form. In particular, the second external magnetic field is not applied to the second raw form after the manufacturing of the second raw form.

According to a further development of the invention, the first magnetic base material is mixed with a first binder, wherein a first mixture of the first magnetic base material and the first binder is obtained. Further, the second magnetic base material is mixed with a second binder, wherein a second mixture of the second magnetic base material and the second binder is obtained. The first mixture is used to manufacture the first raw form and the second mixture is used to manufacture the second raw form.

Additionally, after manufacturing the third raw form, the first binder and the second binder are at least partially, preferably completely, removed from the third raw form. Alternatively, prior to manufacturing the third raw form, the first binder and/or the second binder is at least partially, preferably completely, removed from the first raw form and/or the second raw form.

In an embodiment of the method, the first mixture comprises a volume fraction of at least 45% to at most 75% of the first magnetic base material and a volume fraction of at least 25% to at most 55% of the first binder. Alternatively or additionally, the second mixture comprises a volume fraction of at least 45% to at most 75% of the second magnetic base material and a volume fraction of at least 25% to at most 45% of the second binder. Preferably, the first binder and/or second binder comprises/comprise at least one organic binder component.

Preferably, the first mixture and the second mixture are identical. Alternatively, the first mixture and the second mixture are different, in particular the first mixture and the second mixture comprise different components and/or different proportions by weight of the individual components.

Preferably, the first raw form is heated to a first softening temperature, in particular the first softening temperature of the first mixture, while the external magnetic field is applied. Alternatively or additionally, the second raw form is heated to a second softening temperature, in particular the second softening temperature of the second mixture, while the external magnetic field is applied.

In a further embodiment of the method, the first binder and the second binder are at least partially removed from the third raw form by means of a solvent or a chemical method. In addition, a remaining portion of the first binder and the second binder is optionally removed from the third raw form by means of thermal decomposition, in particular directly before sintering.

According to a further development of the invention, it is provided that a first main component of the first binder and a second main component of the second binder are identical. Advantageously, this enables substance-to-substance bonding of the first raw form and the second raw form, in particular of the first binder and the second binder, —possibly mediated via the separating layer—in the region of the connection surfaces during manufacturing of the third raw form by means of joining.

In an embodiment of the method, the first binder and the second binder are identical.

According to a further development of the invention, it is provided that at least one raw form selected from the first raw form and the second raw form is manufactured by means of a method selected from a group consisting of injection molding, in particular metal powder injection molding, additive manufacturing, extrusion, cold pressing, dry pressing, and wet pressing.

In an embodiment of the method, the first raw form is manufactured by injection molding of the first mixture comprising the first magnetic base material and the first binder. Alternatively or additionally, the second raw form is manufactured by injection molding the second mixture comprising the second magnetic base material and the second binder.

In an embodiment of injection molding, a mold having a cavity is provided. In particular, the cavity comprises at least one separating layer forming substance in the form of an aerosol or a gas. Further, the first mixture is injected into the cavity by means of a first nozzle. A second nozzle, different from the first nozzle, is used to inject the second mixture into the cavity. In particular, the first mixture and the second mixture are injected into the cavity simultaneously or with a time delay. Upon curing of the first mixture and the second mixture, the third raw form is formed, comprising the at least one first raw form and the at least one second raw form. Due to a contact of the first mixture and the second mixture with the separating layer forming substance, the third raw form comprises a separating layer between the at least one first raw form and the at least one second raw form. Particularly preferably, the third raw form may be manufactured by injecting a mixture or a plurality of mixtures into the cavity using a plurality of nozzles.

In a further embodiment of the method, at least one raw form selected from the first raw form and the second raw form is manufactured by cold pressing a magnetic base material. In cold pressing, the particles are mechanically interlocked, in particular under a pressure of up to 1 GPa. In dry cold pressing, in particular no additional liquid component is added to the magnetic base material. In wet cold pressing, at least one organic solvent, preferably a volatile organic solvent, is added to the magnetic base material. The volatile organic solvent is selected from a group consisting of an alcohol, an aliphatic, an acyclic alkane, a cyclic alkane, a ketone, an alkene, an aromatic, and a mixture of volatile organic substances that can serve as solvent. The alcohol used is preferably ethanol or isopropanol. As cyclic alkane, preferably cyclohexane is used. As ketone, preferably acetone is used. The aromatic is preferably benzene, xylene and/or toluene. The mixture of volatile organic substances is preferably selected from a group consisting of petroleum, white spirit, and benzine. The organic solvent serves in particular as a binder during wet cold pressing. Furthermore, the first raw form and/or the second raw form is preferably dried before sintering.

In a further embodiment of the method, the first raw form and the second raw form are manufactured by means of the identical method.

In a further embodiment of the method, the first raw form and the second raw form are first manufactured, and at least one raw form selected from the first raw form and the second raw form is contacted with the separating layer forming substance to form the separating layer. Preferably, the first raw form and the second raw form are contacted with the separating layer forming substance to form the separating layer. Subsequently, the first raw form and the second raw form are joined to form the third raw form, wherein the separating layer is arranged between the first raw form and the second raw form.

According to a further development of the invention, it is provided that the second raw form is injected onto the first raw form by means of injection molding, in particular of the second mixture.

Alternatively or additionally, it is provided that before the second raw form is injected, the separating layer is configured on the first connection surface of the first raw form, wherein the third raw form is manufactured.

Alternatively, it is provided that when the second raw form is injected, the separating layer is configured on the first connecting surface of the first raw form, wherein the third raw form is manufactured.

Alternatively or additionally, it is provided that when the second raw form is injected the separating layer is configured on the second connection surface of the second raw form, wherein the third raw form is manufactured.

Preferably, at least one magnetic base material selected from a group consisting of the first magnetic base material and the second magnetic base material comprises a hard magnetic material, in particular the at least one magnetic base material consists of a hard magnetic material. In particular, the hard magnetic material is an RₓT_{y}B alloy. In addition, at least one magnetic base material selected from a group consisting of the first magnetic base material and the second magnetic base material comprises a soft magnetic or a paramagnetic material, in particular the at most one magnetic base material consists of a soft magnetic or paramagnetic material. Preferably, the first magnetic base material comprises a hard magnetic material or consists of a hard magnetic material, and the second magnetic base material comprises a soft magnetic or paramagnetic material or consists of a soft magnetic or paramagnetic material. Advantageously, a soft magnetic or paramagnetic material can be reworked in a simple manner after sintering, in particular by means of machining.

In an embodiment of the method, the first raw form is provided and the second raw form is manufactured by means of injection molding by injecting the second mixture onto the first raw form. Preferably, the separating layer is configured on the first connection surface of the first raw form prior to injection molding of the second raw form, or the separating layer is configured during injection molding of the second raw form. Preferably, the separating layer is formed during injection molding by comprising at least one separating layer forming substance in the form of an aerosol or a gas in a cavity for producing the second raw form. In particular, the separating layer forming substance is introduced into the cavity for this purpose. The first raw form, the second raw form and the separating layer together form the third raw form. Advantageously, this method can be carried out for a plurality of raw forms.

In a further embodiment of the method, the first raw form and the second raw form are manufactured by means of injection molding, wherein the first raw form is overmolded with the second mixture at least in some areas, wherein the separating layer is configured on the first connection surface of the first raw form before overmolding the first raw form. For manufacturing the first raw form, the first mixture is injected into a first cavity of a mold, wherein preferably the first cavity comprises at least one separating layer forming substance in the form of an aerosol or a gas. Alternatively or additionally, at least one form of a separating layer forming substance selected from a solid, a liquid, a suspension, and a solution is applied to the first raw form, in particular the first connection surface, thereby providing the separating layer. After the first raw form has cooled and/or solidified, the first raw form is placed in a second cavity of the mold, preferably comprising at least one separating layer forming substance in the form of an aerosol or a gas, and the first raw form is overmolded with the second mixture, wherein the second raw form, which at least partially surrounds, preferably encloses, the first raw form, is manufactured. The first raw form, the second raw and the separating layer form together form the third raw form. As the second mixture solidifies, the volume of the second raw form reduces. Therefore, during solidification, the second raw form shrinks onto the first raw form, thereby obtaining a frictional connection of the first raw form and the second raw form. Additionally, depending on the geometry of the first raw form and the second raw form, a form bonding of the first raw form and the second raw form is obtained. Advantageously, this method can be carried out for a plurality of raw forms.

In particular, the at least one separating layer forming substance in the form of an aerosol or a gas is introduced into the cavity such that the at least one separating layer forming substance is stationary in the cavity, or such that the at least one separating layer forming substance flows through the cavity. In particular, the second mixture reacts with the at least one separating layer forming substance during injection into the cavity to form the separating layer.

According to a further development of the invention, it is provided that the third raw form is manufactured by means of a method selected from a group consisting of substance-to-substance bonding, in particular gluing, form bonding, frictional bonding and loose bonding.

In an embodiment of the method, the third raw form is manufactured by substance-to-substance bonding. Preferably, the first binder and the second binder comprise at least one identical binder component. Preferably, the at least one identical binder component is a thermoplastic. Further, the at least one identical binder component is the first main component of the first binder and the second main component of the second binder. Particularly preferably, at least one magnetic base material selected from a group consisting of the first magnetic base material and the second magnetic base material is a hard magnetic material.

In a first embodiment of substance-to-substance bonding, the first connection surface of the first raw form and the second connection surface of the second raw form are heated to a temperature of at least 35° C. to at most 230° C., preferably from at least 70° C. to at most 200° C., in particular by means of a hot plate or a laser, wherein the first connection surface and the second connection surface are melted. Once the first connection surface and the second connection surface are melted, the first connection surface and the second connection surface and the separating layer provided therebetween are pressed together with a pressure of at least 0.001 MPa to at most 10 MPa until the melted connection surfaces have solidified again, wherein the first raw form and the second raw form are substance-to-substance bonded together.

In a second embodiment of substance-to-substance bonding, the first connection surface and the second connection surface and the separating layer provided therebetween are substance-to-substance bonded by friction welding, wherein the third raw form is manufactured.

In a third embodiment of substance-to-substance bonding, the third raw form is manufactured by gluing. Particularly preferably, the first raw form, the second raw form and the separating layer provided therebetween are joined by means of a physically and/or a chemically curing adhesive.

In an embodiment of gluing, a hot melt adhesive which physically cures is used. Preferably, at least one binder is melted and used as an adhesive to join the first raw form, the second raw form and the separating layer provided therebetween together. Preferably, the hot melt adhesive comprises at least one magnetic base material, in particular in powdered form.

In a further embodiment of gluing, an adhesive comprising at least one polymer dissolved in a solvent is used to join the first raw form, the second raw and the separating layer provided therebetween form together. In particular, the solvent in the adhesive is evaporated, whereby an adhesive effect of the adhesive occurs.

In another embodiment of the gluing, an adhesive selected from a group consisting of a cyanoacrylate, an epoxy adhesive, and a phenolic resin is used to join the first raw form, the second raw form and the separating layer provided therebetween together.

In a further embodiment of the method, the third raw form is manufactured by form bonding. Preferably, the first raw form, the second raw form and the separating layer provided therebetween can be form bonded together via their respective geometries, in particular via a tongue and groove geometry, a screw thread geometry or a pin hole geometry. Preferably, at least one magnetic base material selected from a group consisting of the first magnetic base material and the second magnetic base material is a hard magnetic material.

In an embodiment of form bonding, a geometry enabling form bonding is configured during manufacturing of the first raw form and the second raw form.

In a further embodiment of form bonding, the geometry enabling form bonding is configured after manufacturing of the first raw form and the second raw form, in particular by means of machining.

In a further embodiment of the form bonding, the geometry enabling the form bonding is configured during the manufacturing of the first raw form and after the manufacturing of the second raw form, in particular by means of machining.

In a further embodiment of the method, the third raw form is manufactured by means of frictional bonding, in particular by means of a thread or an interference fit. Preferably, at least one magnetic base material selected from a group consisting of the first magnetic base material and the second magnetic base material is a hard magnetic material.

In a further embodiment of the method, the third raw form is manufactured by loose bonding of the first raw form, the second raw form and the separating layer provided therebetween. Advantageously, loose bonding of the first raw form, the second raw form and the separating layer provided therebetween after sintering produces a frictional and/or substance-to-substance bonding for the obtained raw magnet. Preferably, at least one magnetic base material selected from a group consisting of the first magnetic base material and the second magnetic base material is a hard magnetic material.

In an embodiment of loose bonding, the first raw form comprises a recess in which the separating layer is provided and the second raw form is arranged. Preferably, the recess comprises a larger dimension than the second raw form. In particular, the first raw form comprises a first volume shrinkage of at least 15% to at most 20% during sintering. In addition, the second raw form exhibits a second volume shrinkage of at least 15% to at most 20% during sintering. Additionally, in particular the second volume shrinkage is lower than the first volume shrinkage. Advantageously, the second raw form is frictionally clamped in the recess of the first raw form during sintering due to the second volume shrinkage, which is lower than the first volume shrinkage of the first raw form, wherein the separating layer is provided between the first raw form and the second raw form. In addition, the first raw form, which corresponds to the surface of the recess, and the second raw form, which is arranged in the recess, are substance-to-substance bonded to one another in the region of the connection surfaces—if appropriate, mediated via the separating layer.

In particular, when the first raw form is manufactured from the first mixture and the second raw form is manufactured from the second mixture, the first volume shrinkage and the second volume shrinkage different from the first volume shrinkage are achieved by a first portion of the first magnetic base material in the first mixture being different from a second portion of the second magnetic base material in the second mixture.

Alternatively or additionally, when the first raw form is manufactured from the first magnetic base material and the second raw form is manufactured from the second magnetic base material, the first volume shrinkage and the second volume shrinkage different from the first volume shrinkage are achieved by differentiating a first raw form density obtained in particular in the dry pressing with a first pressure from a second raw form density obtained in particular in the dry pressing with a second pressure different from the first pressure.

In a further embodiment of loose bonding, the first raw form, the second raw form and the separating layer are loosely layered to produce the third raw form, wherein substance-to-substance bonding of the first raw form, the second raw form and the separating layer is obtained during sintering. Preferably, a plurality of first raw forms, a plurality of second raw forms and a plurality of separating layers are loosely layered to manufacture the third raw form.

According to a further development of the invention, it is provided that the first binder and the second binder comprise at least one material selected from a group consisting of polyoxymethylene, polypropylene, paraffin wax, polyethylene and polyamide. Advantageously, polyoxymethylene, polypropylene, paraffin wax, polyethylene and polyamide are thermoplastics and are therefore suitable for the configuration of a substance-to-substance bonding of the first raw form and the second raw form. Furthermore, the at least one material selected from a group consisting of polyoxymethylene, polypropylene, paraffin wax, polyethylene and polyamide facilitates an alignment of the particles of the first magnetic base material and the second magnetic base material.

According to a further development of the invention, it is provided that the third raw form is at least partially, preferably completely, debinded. Preferably, during the debinding, the at least one binder component is at least partially, preferably completely, removed from the third raw form.

Preferably, the third raw form is partially debinded by means of a solvent. Subsequently, preferably a thermal debinding is carried out, in particular the thermal debinding is carried out before sintering.

Alternatively, the third raw form is completely debinded by means of a solvent, in particular the third raw form is debinded before sintering.

According to a further development of the invention, it is provided that the third raw form is sintered in an atmosphere comprising at least one process gas selected from a group consisting of argon and helium. Particularly preferably, the atmosphere in which the third raw form is sintered consists of at least one process gas selected from a group consisting of argon and helium. Alternatively, the third raw form is preferably sintered in a vacuum.

In a preferred embodiment, the raw magnet is configured as a Halbach-Array.

The problem is also solved by providing a permanent magnet which comprises at least one separating layer arranged in an interior of the permanent magnet, preferably as an electrical resistance layer or as an electrically insulating layer. In particular, the permanent magnet is manufactured in a method according to the invention or in a method according to one or more of the embodiments described above. In connection with the permanent magnet, the advantages already explained in connection with the method arise in particular.

In an embodiment, the permanent magnet comprises at least five separating layers, preferably at least ten separating layers, preferably at least 15 separating layers, particularly preferably 20 separating layers, in the interior of the permanent magnet, wherein one separating layer is arranged between each two layers of the permanent magnet formed from a respective raw form.

The invention further includes a use of such a permanent magnet in a device selected from a group consisting of an electric motor, a loudspeaker, a microphone, a generator, a hard disk drive, and a sensor.

The invention also includes a device selected from a group consisting of an electric motor, a loudspeaker, a microphone, a generator, a hard disk drive, and a sensor, wherein the device comprises a permanent magnet provided by a method according to the invention or a method according to one or more of the embodiments described above.

The invention is explained in more detail below with reference to the drawing. Thereby show:

FIG. 1 a flow diagram of a first embodiment of a method for manufacturing a raw magnet,

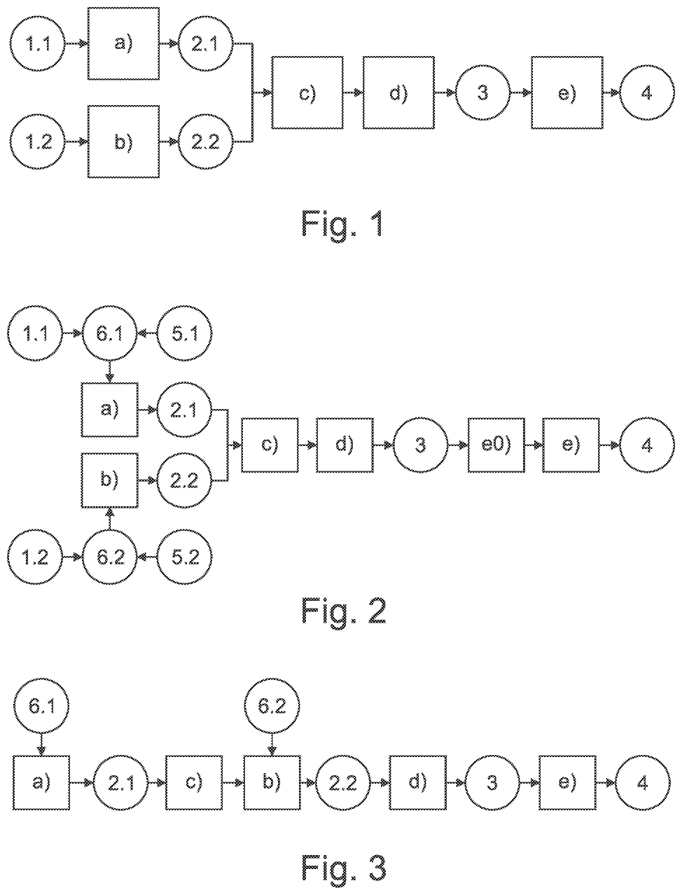

FIG. 2 a flow diagram of a second embodiment of the method for manufacturing the raw magnet,

FIG. 3 a flow diagram of a third embodiment of the method for manufacturing the raw magnet,

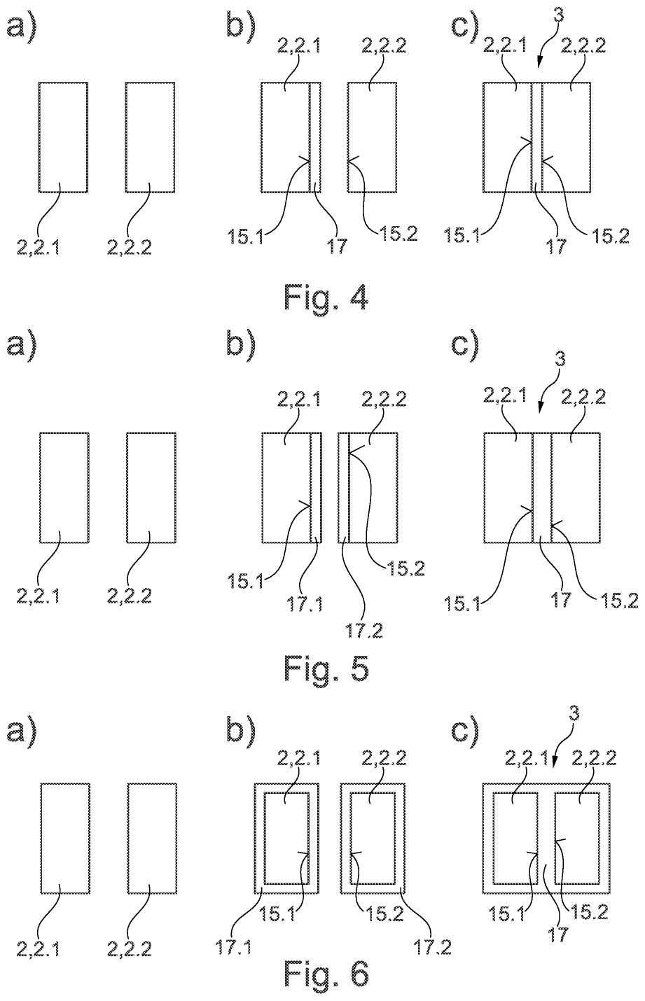

FIG. 4 a schematic representation of a first embodiment for manufacturing a third raw form, and

FIG. 5 a schematic representation of a second embodiment for manufacturing the third raw form,

FIG. 6 a schematic representation of a third embodiment for manufacturing the third raw form,

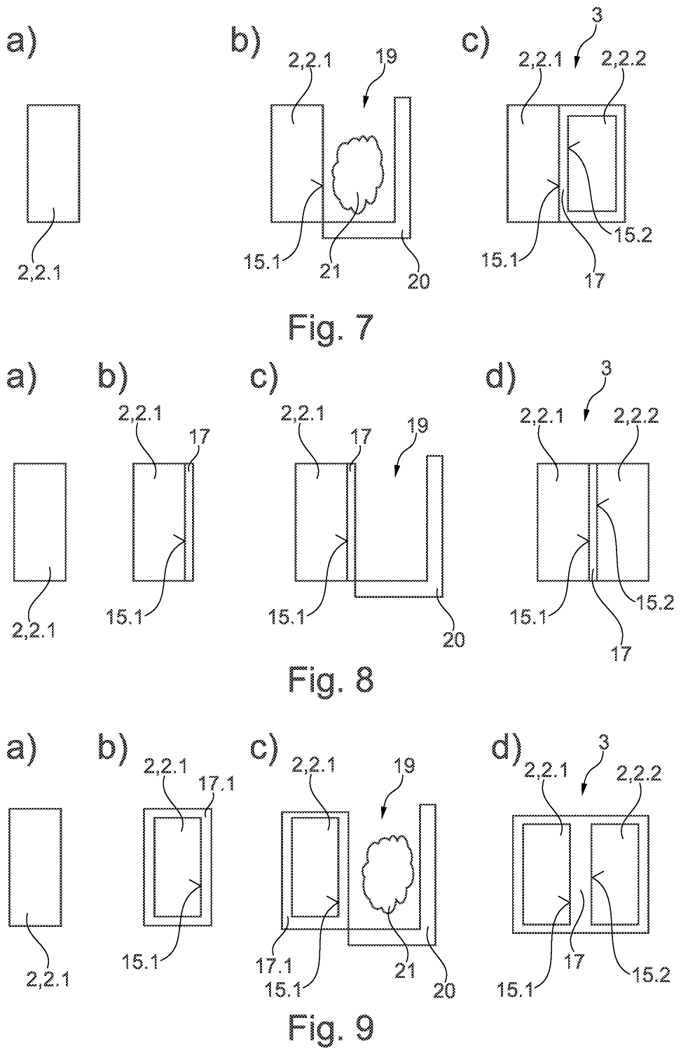

FIG. 7 a schematic representation of a fourth embodiment for manufacturing the third raw form,

FIG. 8 a schematic representation of a fifth embodiment for manufacturing the third raw form, and

FIG. 9 a schematic representation of a sixth embodiment for manufacturing the third raw form.

FIG. 1 shows a flow diagram of a first embodiment of a method for manufacturing a raw magnet 4.

In a step a), a first raw form 2.1 is manufactured from a first magnetic base material 1.1.

In a step b), a second raw form 2.2 is manufactured from a second magnetic base material 1.2.

Particularly preferably, as the first magnetic base material 1.1 and/or as the second magnetic base material 1.2, a material is used which is made from particles of an RₓT_{y}B alloy and preferably particles of a rare-earth-rich phase. Alternatively, as the first magnetic base material 1.1 and/or as the second magnetic base material 1.2, a material selected from a group consisting of an aluminium-nickel-cobalt alloy, a samarium-cobalt alloy, and a ferrite alloy is used.

An external magnetic field 21 is applied to at least one raw form 2 selected from a group consisting of the first raw form 2.1 and the second raw form 2.2 during and/or after manufacturing of the raw form 2 according to step a) or b).

Preferably, the first raw form 2.1 is manufactured in the externally applied magnetic field 21. Alternatively or additionally, the external magnetic field 21 is applied to the first raw form 2.1 after manufacturing of the first raw form 2.1. Alternatively or additionally, the second raw form 2.2 is manufactured in the externally applied magnetic field 21. Alternatively or additionally, the external magnetic field 21 is applied to the second raw form 2.2 after manufacturing of the second raw form 2.2.

Preferably, at least one raw form 2 selected from the first raw form 2.1 and the second raw form 2.2 is manufactured, in particular in the step a) and/or in the step b), by means of a method selected from a group consisting of injection molding, additive manufacturing, extrusion, cold pressing, dry pressing, and wet pressing.

In a step c), a separating layer 17 is provided between a first connection surface 15.1 of the first raw form 2.1 and a second connection surface 15.2 of the second raw form 2.2.

In a step d), the first raw form 2.1 and the second raw form 2.2 and the separating layer 17 provided therebetween are joined together by means of joining, wherein a third raw form 3 is manufactured.

The third raw form 3 is preferably manufactured by means of a method selected from a group consisting of substance-to-substance bonding, in particular gluing, form bonding, frictional bonding, and loose bonding.

In a step e), the third raw form 3 is sintered, wherein the raw magnet 4 is obtained. Preferably, the third raw form 3 is sintered in an atmosphere comprising at least one process gas selected from a group consisting of argon and helium. Particularly preferably, the atmosphere consists of at least one process gas selected from a group consisting of argon and helium. Alternatively, the third raw form 3 is sintered in a vacuum.

FIG. 2 shows a flow diagram of a second embodiment of a method for manufacturing the raw magnet 4.

Identical and functionally identical elements are provided with the same reference signs in all figures, so that reference is made to the preceding description in each case.

Furthermore, identical or functionally identical process steps are provided with identical letters, so that reference is made to the previous description in each case.

The first magnetic base material 1.1 is mixed with a first binder 5.1, wherein a first mixture 6.1 is obtained from the first magnetic base material 1.1 and the first binder 5.1. In step a), the first mixture 6.1 is used to manufacture the first raw form 2.1.

The second magnetic base material 1.2 is mixed with a second binder 5.2, wherein a second mixture 6.2 is obtained from the second magnetic base material 1.2 and the second binder 5.2. In step b), the second mixture 6.2 is used to manufacture the second raw form 2.2.

In step c), the separating layer 17 is provided between the first connection surface 15.1 of the first raw form 2.1 and the second connection surface 15.2 of the second raw form 2.2.

In step d), the first raw form 2.1 and the second raw form 2.2 and the separating layer 17 provided therebetween are joined together by means of joining, wherein the third raw form 3 is produced.

In a step e0) the first binder 5.1 and the second binder 5.2 are at least partially, preferably completely, removed from the third raw form 3 before sintering and after manufacturing the third raw form 3.

Preferably, a first main component of the first binder 5.1 and a second main component of the second binder 5.2 are identical. Alternatively or additionally, the first binder 5.1 and the second binder 5.2 comprise at least one substance selected from a group consisting of polyoxymethylene, polypropylene, paraffin wax, polyethylene and polyamide.

FIG. 3 shows a flow diagram of a third embodiment of a method for manufacturing the raw magnet 4.

The first raw form 2.1 and the second raw form 2.2 are preferably not manufactured separately from each other. In step a), the first raw form 2.1 is manufactured from the first mixture 6.1 by means of injection molding. In step c), either before step b) or during step b), the separating layer 17 is provided between the first raw form 2.1 and the second raw form 2.2. In step b), the first raw form 2.1 is overmolded with the second mixture 6.2 by means of injection molding. Alternatively, in step b) the second mixture 6.2 is injection molded onto the first raw form 2.1 by means of injection molding. In step b), the second raw form 2.2 is thus manufactured, wherein the separating layer 17 is arranged and/or configured between the first raw form 2.1 and the second raw form 2.2. In step d), the second raw form 2.2 preferably solidifies and thus shrinks onto the first raw form 2.1 and/or joins with the first raw form 2.1, wherein the third raw form 3 is manufactured.

FIG. 4 shows a schematic representation of a first embodiment for manufacturing the third raw form 3.

In FIG. 4 a) the first raw form 2.1 and the second raw form 2.2 are provided. In FIG. 4 b) the separating layer 17 is configured on a first connection surface 15.1 of the first raw form 2.1. In FIG. 4 c) the first raw form 2.1, the second raw form 2.2 and the separating layer 17 provided therebetween are joined, wherein the third raw form 3 is manufactured.

FIG. 5 shows a schematic representation of a second embodiment for manufacturing the third raw form 3.

In FIG. 5 a) the first raw form 2.1 and the second raw form 2.2 are prepared. In FIG. 5 b) a first separating layer 17.1 is configured on the first connection surface 15.1 of the first raw form 2.1 and a second separating layer 17.2 is configured on a second connection surface 15.2 of the second raw form 2.2. In FIG. 5 c) the first raw form 2.1, the second raw form 2.2 are joined, wherein the separating layer 17 is obtained from the first separating layer 17.1 and the second separating layer 17.2 and the third raw form 3 is manufactured.

FIG. 6 shows a schematic representation of a third embodiment for manufacturing the third raw form 3.

In FIG. 6 a) the first raw form 2.1 and the second raw form 2.2 are prepared. In FIG. 6 b), the first separating layer 17.1 is configured on the first raw form 2.1 and a second separating layer 17.2 is configured on the second raw form 2.2. The separating layers 17.1 and 17.2 preferably completely surround the respective raw forms 2.1 and 2.2. In FIG. 6 c) the first raw form 2.1 and the second raw form 2.2 are joined, wherein the separating layer 17 is obtained from the first separating layer 17.1 and the second separating layer 17.2 in the region of the first connection surface 15.1 and the second connection surface 15.2. At the same time, the third raw form 3 is manufactured.

FIG. 7 shows a schematic representation of a fourth embodiment for manufacturing the third raw form 3.

In FIG. 7 a) the first raw form 2.1 is prepared. In FIG. 7 b) the first raw form 2.1 is arranged at a cavity 19, wherein the cavity 19 comprises at least one separating layer forming substance 21 in the form of an aerosol or a gas. Subsequently, the second raw form 2.2 is injection molded by filling the cavity 19 of a mold 20 with the second mixture 6.1. Due to the at least one separating layer forming substance 21 in the cavity 19, the separating layer 17 forms on the second raw form 2.2. The separating layer 17 preferably completely surrounds the second raw form 2.2. FIG. 7 c) shows the third raw form 3 after solidification of the second mixture 6.2 without the mold 20.

FIG. 8 shows a schematic representation of a fifth embodiment for manufacturing the third raw form 3.

In FIG. 8 a) the first raw form 2.1 is provided. In FIG. 8 b) the separating layer 17 is configured on the first raw form 2.1. In FIG. 8 c), the first raw form 2.1 is arranged on the cavity 19 of the mold 20. The second raw form 2.2 is then injection molded by filling the cavity 19 with the second mixture 6.1. FIG. 8 d) shows the third raw form 3 after solidification of the second mixture 6.2 without the mold 20.

FIG. 9 shows a schematic representation of a sixth embodiment for manufacturing the third raw form 3.

In FIG. 9 a) the first raw form 2.1 is provided. In FIG. 9 b) the first separating layer 17.1 is configured on the first raw form 2.1, wherein the first separating layer 17.1 preferably completely surrounds the first raw form. In FIG. 9 c), the first raw form 2.1 is arranged on the cavity 19 of the mold 20, wherein the cavity 19 comprises at least one separating layer forming substance 21 in the form of an aerosol or a gas. Subsequently, the second raw form 2.2 is injection molded by filling the cavity 19 with the second mixture 6.1. Due to the at least one separating layer forming substance 21 in the cavity 19, the second separating layer 17.2 forms on the second raw form 2.2. The second separating layer 17.2 preferably completely surrounds the second raw form 2.2. In FIG. 9 d) the third raw form 3 is shown after solidification of the second mixture 6.2 without the mold 20, wherein the separating layer 17 is obtained from the first separating layer 17.1 and the second separating layer 17.2 in the region of the first connection surface 15.1 and the second connection surface 15.2.

1. A method for manufacturing a raw magnet, the method comprising:
manufacturing a first raw form from a first magnetic base material;
manufacturing a second raw form from a second magnetic base material;
applying an external magnetic field to at least one raw form selected from a group consisting of the first raw form and the second raw form during and/or after manufacturing of the first and second raw forms,
manufacturing a third raw form from the first raw form and the second raw form by joining the first and second raw forms together;
wherein a separating layer is provided between a first connection surface of the first raw form and a second connection surface of the second raw form, and wherein
the third raw form is sintered, wherein the raw magnet is obtained.

2. The method according to claim 1, wherein the separating layer is configured as an electrically insulating layer having a lower electrical conductivity than at least one of the first magnetic base material and the second magnetic base material.

3. The method according to claim 1, wherein the separating layer is configured by bringing a separating layer forming substance into contact with at least one connection surface selected from the first connection surface and the second connection surface.

4. The method according to claim 1, wherein the separating layer forming substance comprises at least one substance selected from a group consisting of aluminium oxide, zirconium oxide, yttrium oxide, neodymium oxide, boron oxide, at least one rare-earth-oxide, neodymium fluoride, praseodymium fluoride, dysprosium fluoride, at least one rare-earth-halide, at least one ceramic material, sodium fluoride, potassium fluoride, sodium chloride, potassium chloride, ammonium fluoride, aluminium fluoride, ammonium nitrate, potassium nitrate, sodium nitrate, iron nitrate, calcium nitrate, aluminium nitrate, oxygen, nitrogen, fluorine, chlorine, bromine, iodine, at least one oxidizing gas, an oxidizing liquid, in particular an oxidizing acid, in particular concentrated sulphuric acid, fuming sulphuric acid, concentrated nitric acid, fuming nitric acid, aqua regia, water vapour, water, and at least one organic polar solvent.

5. The method according to claim 1, wherein at least one of the first magnetic base material and the second magnetic base material is made of a material including particles of an RₓT_{y}B alloy.

6. The method according to claim 1, wherein at least one of the first magnetic base material and the second magnetic base material is made of a material including particles selected from a group consisting of an aluminium-nickel-cobalt alloy and a samarium-cobalt alloy.

7. The method according to claim 1, wherein:
the first magnetic base material is mixed with a first binder, wherein
a first mixture of the first magnetic base material and the first binder is obtained, wherein
the first raw form is manufactured from the first mixture, wherein
the second magnetic base material is mixed with a second binder, wherein
a second mixture of the second magnetic base material and the second binder is obtained, wherein
the second raw form is manufactured from the second mixture, wherein
the first binder and the second binder are at least partially removed from the first raw form and/or the second raw form after and/or before manufacturing the third raw form and before sintering.

8. The method according to claim 1, wherein at least one raw form selected from the first raw form and the second raw form is manufactured by a method selected from a group consisting of injection molding, additive manufacturing, extrusion, cold pressing, dry pressing, and wet pressing.

9. The method according to claim 1, wherein the second raw form is injection molded onto the first raw form by injection molding.

10. The method according to claim 9, wherein:
the wherein the separating layer is configured on the first connection surface of the first raw form before the second raw form is injected, wherein the third raw form is manufactured, or
when the second raw form is injected, the separating layer is configured on the first connection surface of the first raw form and/or on the second connection surface of the second raw form, wherein the third raw form is manufactured.

11. The method according to claim 1, wherein the third raw form is manufactured by substance-to-substance bonding.

12. The method according to claim 1, wherein the first binder and the second binder comprise at least one compound selected from a group consisting of polyoxymethylene, polypropylene, paraffin wax, polyethylene and polyamide.

13. The method according to claim 1, wherein the third raw form is sintered in a vacuum or in an atmosphere comprising at least one process gas selected from a group consisting of argon and helium.

14. A permanent magnet manufactured according to the method of claim 1, wherein the permanent magnet comprises at least one separating layer arranged in an interior of the permanent magnet.

15. The permanent magnet of claim 14, wherein the at least one separating layer is an electrical resistance layer.

16. The method according to claim 3, wherein:
the separating layer forming substance forms the separating layer, or
at least one of the first magnetic base material and the second magnetic base material reacts with the separating layer forming substance, wherein the separating layer is formed.

17. The method according to claim 5, wherein at least one of the first magnetic base material and the second magnetic base material is made of a material including particles of a rare-earth-rich phase.

18. The method according to claim 9, wherein the second raw form is injection molded onto the first raw form by injection molding of the second mixture.
